(19) United States
(12) Patent Application Publication
(10) Pub. No.: US 2015/0332063 A1
(43) Pub. Date: Nov. 19, 2015

(54) DOCUMENT MANAGEMENT APPARATUS, DOCUMENT MANAGEMENT METHOD, AND NON-TRANSITORY COMPUTER READABLE MEDIUM

(71) Applicant: FUJI XEROX CO., LTD., Tokyo (JP)

(72) Inventor: Yoshihiro MASUDA, Kanagawa (JP)

(21) Appl. No.: 14/543,197

(22) Filed: Nov. 17, 2014

(30) Foreign Application Priority Data
May 16, 2014 (JP) 2014-101924

(51) Int. Cl. G06F 21/62; G06F 17/30

(52) U.S. Cl. CPC G06F 21/6218; G06F 17/30876; G06F 17/30011; G06F 17/30867

(57) ABSTRACT

A document management apparatus includes a receiving unit and a granting unit. The receiving unit receives a document to which a first user has an access right and an action history of the first user. If the similarity between the action history of the first user and an action history of a second user is higher than or equal to a threshold value, the granting unit grants the access right to the document to the second user.

### CROSS-REFERENCE TO RELATED APPLICATIONS

This application is based on and claims priority under 35 USC 119 from Japanese Patent Application No. 2014-101924 filed May 16, 2014.

### BACKGROUND

### Technical Field

The present invention relates to a document management apparatus, a document management method, and a non-transitory computer readable medium.

### SUMMARY

According to an aspect of the invention, there is provided a document management apparatus including a receiving unit and a granting unit. The receiving unit receives a document to which a first user has an access right and an action history of the first user, if the similarity between the action history of the first user and an action history of a second user is higher than or equal to a threshold value, the granting unit grants the access right to the document to the second user.

### BRIEF DESCRIPTION OF THE DRAWINGS

Exemplary embodiments of the present invention will be described in detail based on the following figures, wherein:

FIG. 1 illustrates an exemplary conceptual module configuration of an information processing apparatus according to an exemplary embodiment;

FIG. 2 illustrates an exemplary system configuration when the present exemplary embodiment is realized;

FIGS. 3A and 3B are explanatory diagrams illustrating an exemplary process according to the present exemplary embodiment;

FIG. 4 illustrates an exemplary data structure of targets in the present exemplary embodiment;

FIG. 5 is a flowchart illustrating an exemplary process according to the exemplary embodiment;

FIG. 6 is a flowchart illustrating another exemplary process according to the exemplary embodiment;

FIG. 7 is a flowchart illustrating another exemplary process according to the exemplary embodiment;

FIG. 8 illustrates an exemplary data structure of user A schedule data;

FIG. 9 illustrates an exemplary data structure of user B schedule data;

FIG. 10 illustrates an exemplary data structure of user C schedule data;

FIG. 11 illustrates an exemplary data structure of a degree of commonality and access right correspondence table; and

FIG. 12 is a block diagram illustrating an exemplary hardware configuration of a computer realizing the present exemplary embodiment.

### DETAILED DESCRIPTION

Technologies on which exemplary embodiments ox present invention are based will now be described before the exemplary embodiments are described. This description is intended to make the understanding of the exemplary embodiments easy.

Access rights to documents are managed by an access right management mechanism, such as Digital Rights Management (DRM) or a document management server. In the case of a general access right management method (a discretionary access control method), creators of the documents grant the access rights to the documents.

However, the grant of the access rights to the documents is a complicated operation. The access rights may possibly be granted to third parties carelessly or no access right may possibly be set for users who require the access rights.

In the exemplary embodiments, the grant of the access rights to the documents and deletion of inappropriate access rights are based on action histories of users.

Exemplary embodiments of the present invention will herein be described with reference to the attached drawings.

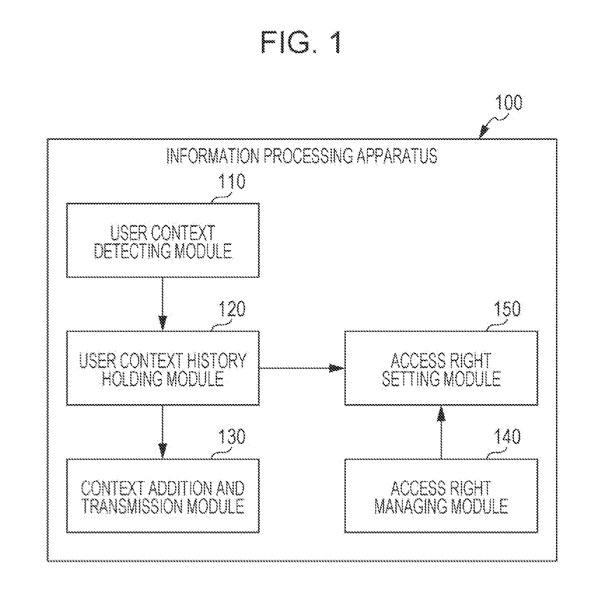

The drawings indicate the exemplary embodiments. FIG. 1 illustrates an exemplary conceptual module configuration of an information processing apparatus according to an exemplary embodiment.

The modules generally mean parts including software (computer program) and hardware, which are capable of being logically separated. Accordingly, the modules in the exemplary embodiments mean not only the modules in the computer program bat also the modules in the hardware configuration. The computer program causing the computer to function as the modules (a program causing the computer to execute the respective procedures, a program causing the computer to function as the respective units, or a program causing the computer to realize the respective functions), a system, and a method are described in the exemplary embodiments. Although “store”, “causing the computer to store”, and similar phrases are used for convenience, these phrases mean storing the computer program in a memory or causing the computer to store the computer program in the memory when the computer program is embodied. Although the module may have one-to-one correspondence with the function, one module may be composed of one program, multiple modules may be composed of one program, or one module may be composed of multiple programs in installation. The multiple modules may be executed by one computer or one module may be executed by multiple computers in distributed or parallel environment. Other modules may be included in one module. “Connection” is hereinafter used not only for physical connection but also for logical connection (exchange of data, instruction, reference relationship between pieces of data, etc.). “Predetermined” means that something is determined before a target process and includes, in addition to determination before the process according to an exemplary embodiment is started, determination based on the current status or state or the past status or state before the target process even if the process according to the exemplary embodiment is started. When multiple “predetermined values” exist, the predetermined values may be different from each other or two or more (including all) of the multiple predetermined values may be equal to each other. A description meaning that “B is performed if A” is used to mean that “it is determined whether A and, if it is determined that A, B is performed.” However, cases in which the determination of whether A is not necessary are excluded.

A system or an apparatus may be realized by one computer, one piece of hardware, one unit, or the like, in addition to a configuration in which multiple computers, multiple pieces of hardware, multiple units, and the likes are connected to each other via a communication unit, such as a network (including one-to-one correspondence communication connection). The “apparatus” and the “system” are used as synonyms. The “system” does not include a social “mechanism” (social system), which is artificial agreement.

When multiple processes are performed for every process in each module or in the module, target information is read out from the memory for each process, the process is performed, and the result of the process is written out onto the memory. Accordingly, a description of the reading from the memory before the process and writing out onto the memory after the process may be omitted. The memory may be a hard disk, a random access memory (RAM), an external storage medium, a memory via a communication line, a register in a central processing unit (CPU), or the like.

An information processing apparatus 100 according to an exemplary embodiment grants an access right to a document. Referring to FIG. 1, the information processing apparatus 100 includes a user context detecting module 110, a user context history holding module 120, a context addition and transmission module 130, an access right managing module 140, and an access right setting module 150.

The document is mainly text data and, in some cases, electronic data (also called a file) indicating graphics, images, movies, audio, etc. or a combination of the text data and the electronic data. The document is the one that is subjected to storage, editing, search, and so on and that is capable of being exchanged between systems or users as an individual unit and may be the one similar to the above one. Specifically, the document is a document created by a document creation program, a Web page, or the like.

The user context detecting module 110 is connected to the user context history holding module 120. The user context detecting module 110 detects a context of a user (for example, a transmitter or a receiver).

The context is detected in the following manners:

The context is extracted from a calendar of the user. Past schedules may be extracted from the calendar as the contexts (the schedules are considered to be actually followed). The calendar may be a shared calendar or may be a personal calendar as long as the user context detecting module 110 is capable of extracting the schedules from the calendar.

A history of transmission and reception of electronic mails between users is extracted from a mail server or the like. A history of usage of a social network service (SNS) or the like may be extracted.

A history of, for example, dates and times when the information processing apparatus is used is extracted. The information processing apparatus is, for example, a multi-function peripheral (an image processing apparatus having two or more of the functions of a scanner, a printer, a copier, a facsimile, and so on) or a personal computer (PC). Specifically, identification information about the user, the date and time (year, month, day, time, minute, second, a unit smaller than the second, or a combination of them) when the user uses the multi-function peripheral, an operation history, and so on may be extracted from an integrated circuit (IC) card used when the multi-function peripheral is used. A log of the dates and times when the user logs on the PC and a usage history may be extracted from the PC.

A movement history (including location information indicating, for example, latitudes and longitudes) or the like of the user, which is output from a global positioning system (GPS) incorporated in a mobile information terminal carried by the user, may be extracted.

The user context history holding module 120 is connected to the user context detecting module 110, the context addition and transmission module 130, and the access right setting module 150. The user context history holding module 120 holds an action history of the user as the context. The context of the user, who is the transmitter of the document, is extracted from the context addition and transmission module 130 and the context of the user, who is the receiver of the document, is extracted from the access right setting module 150.

The context addition and transmission module 130 is connected to the user context history holding module 120. The context addition and transmission module 130 adds the context (the context of the transmitter) to the document to be transmitted and transmits the document to the receiver. The transmission here includes, for example, transmission using an electronic mail and copying to a shared server. The addition of the context is realized in the following manners:

Context information itself is added to the document for transmission.

Storage destination information in the context information is added to the document for transmission. The storage destination information is a so-called link destination and is, for example, a uniform resource locator (URL) indicating the location where the document is stored.

The access right managing module 140 is connected to the access right setting module 150. The access right managing module 140 manages an access control list (ACL) of the document in accordance with the access right set by the access right setting module 150.

The access right setting module 150 is connected to the user context history holding module 120 and the access right managing module 140. The access right setting module 150 grants the access right on the basis of the result of comparison between the context added to the received document and the context of the receiver. The access right setting module 150 receives the document (the received document here), to which a first user (the transmitter here) has the access right and the action history of the first user. If the similarity between the action history of the first user and the action history of a second user (the receiver here) is higher than or equal to a threshold value, the access right setting module 150 grants the access right to the document to the second user. The threshold value may be a predetermined value.

The access right granted to the second user by the access right setting module 150 is the access right equal to or lower than the access right which the first user has for the document. It means that the access right of the second user is equal to the access right of the first user, or that restriction of the access right of the second user is stronger than that of the access right of the first user. For example, when the access right of the first user is a Deletion right, the access right lower than or equal to the access right which the first user has can be any of the Deletion right, a Write right, and a Read right or a combination of therm. When the access right of the first user is the Write right, the access right lower than or equal to the access right which the first user has can be either of the Write right and the Read right or a combination of therm. When the access right of the first user is the Read right, the access right lower than or equal to the access right which the first user has can be the Read right.

The access right setting module 150 may calculate the similarity between the first and second users' actions during a process of creating the document.

The access right setting module 150 may calculate the similarity between the first and second users' actions of a predetermined period of time. The “predetermined period of time” may a predetermined period back from the current date and time (the date and time when the grant of the access right is performed) toward the past, or a predetermined period from the date and time when the document is created.

The access right setting module 150 may have multiple threshold values and may grant the access right to the document to the second user in a stepwise manner. In other words, the access right setting module 150 may grant multiple kinds of access right based on the corresponding multiple threshold values of similarity.

The determination of the similarity in the context and the grant of the access right, which are performed by the access right setting module 150, may be specifically performed, for example, in the foil owing manner:

The degree of commonality is calculated from a common point on the contexts according to the following computation equation and the Read right and/or the Write right are granted on the basis of the threshold value.

The degree of context commonality=Shared time/target period of time

The target period of time may be a predetermined period back from the current time, or may be a predetermined period since the document has been created (for example, one week since the document has been created).

When the threshold values of two kinds (a threshold value (r/w) and a threshold value (ro) exist, the determination and the grant of the access right are performed in the following manner. It is assumed here that the creator of the document has the Delete right, the Write right, and the Read right to the document.

If the threshold value (r/w)<the degree of context commonality, the Write right and the Read right of the user are added to the document.

If the threshold value (ro)<the degree of context commonality, the Read right of the user is added to the document.

The access right setting module 150 may perform the grant of the access right when the document is passed from the first user to the second user. The access right setting module 150 also may delete the access right to the document, which is granted to the second user, if the similarity between the action history of the first user and the action history of the second user got lower than or equal to the threshold value for every predetermined period after the access right is granted. Alternatively, the access right setting module 150 may re-grant the access right to the document to the second user if the similarity between the action history of the first user and the action history of the second user is higher than or equal to the threshold value after an expiry date of the access right granted. The “for every predetermined period” may be a predetermined date and time (for example, every end of month or every weekend) or may be a period from the time when the access right is granted.

For example, when a predetermined expiry date is set for the access right and access is performed after the expiry date, the comparison of the contexts may be performed again to grant the access right. The access right is not granted if the condition is not met.

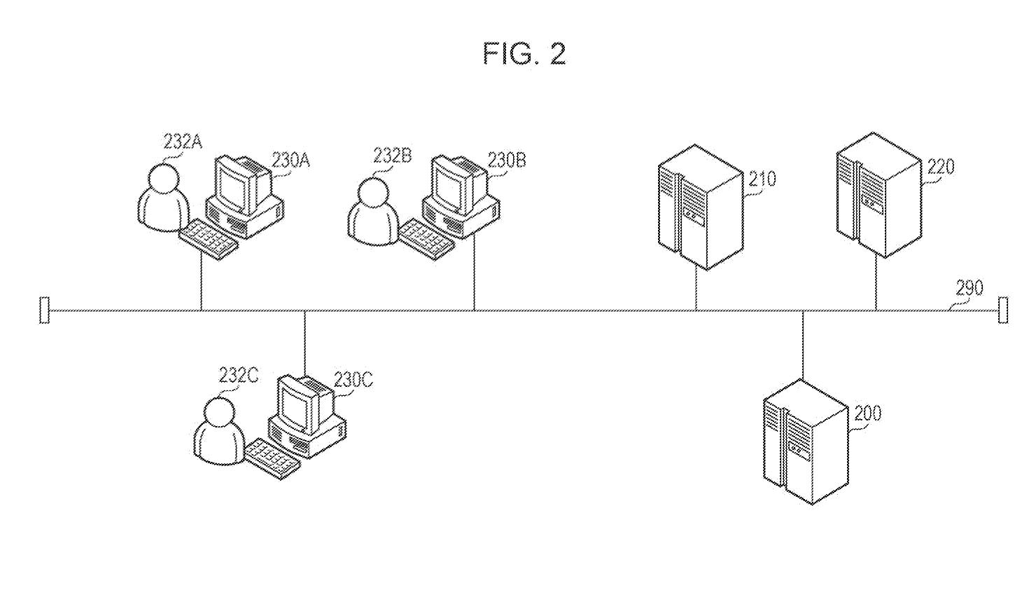

FIG. 2 illustrates an exemplary system configuration when the present exemplary embodiment is realized.

Referring to FIG. 2, an access right grant service apparatus 200, a document sharing server 210, a schedule management system 220, a client terminal 230A used by a user A: 232A, a client terminal 230B used by a user B: 232B, and a client terminal 230C used by a user C: 232C are connected to each other via a communication line 290. The client terminal 230A, the client terminal 230B, and the client terminal 230C each have the context addition and transmission module 130 illustrated in FIG. 1. The document sharing server 210 stores the document shared between the user A: 232A, the user B: 232B, and the user C: 232C. Information indicating the creator (for example, a user identifier (ID)) and the ACL are added to the document as attribute information. The schedule management system 220 stores schedule information about the user A: 232A, the user B: 232B, and the user C: 232C. The schedule management system 220 includes the user context history holding module 120 illustrated in FIG. 1. Here, the context is extracted from the schedule information. When the document is passed from the first user to the second user, the access right grant service apparatus 200 grants the access right to the document to the second user. The access right grant service apparatus 200 includes the access right managing module 140 and the access right setting module 150 illustrated in FIG. 1.

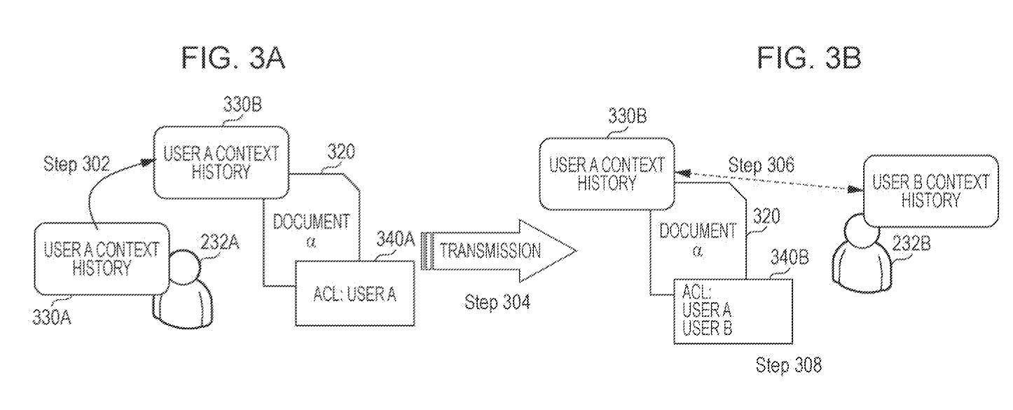

FIGS. 3A and 3B are explanatory diagrams illustrating an exemplary process according to the present exemplary embodiment.

Referring to FIG. 3A, in Step302, the context is added when transmitting the document. The client terminal 230A extracts a user A context history 330A (for example, information indicating when and where the user A: 232A did what and which device the user A: 232A used for a period of time) of the user A: 232A, who is the transmitter, from the schedule management system 220 or the like when transmitting a document α 320, and adds a user A context history 330B that is extracted to the document α 320. The access right to the document α 320 as of this time is an “ACL: user A” 340A.

In Step304, the document α 320 to which the user A context history 330B is added is transmitted to the user B: 232B.

Referring to FIG. 1B, in Step306, the access right grant service apparatus 200 compares the context of the user A: 232A with the context of the user B: 2323.

In Step308, the access right grant service apparatus 200 grants the access right in accordance with the result of the comparison.

If the user B: 232B who receives the document α 320, to which the user A context history 330B is added, has the context which is similar to the context of the user A: 232A, the access right of the user A: 232A (“ACL: user A” 340A) is granted to the user B: 232B. As a result, the access right to the document α 320 becomes an “ACL: user A user B” 340B.

A collection of the users registered as the ones who have the access rights to the document α 320 is periodically compared with the context of the user A; 232A (the creator of the document α 320), and the access right of an inappropriate user, if detected, may be deleted.

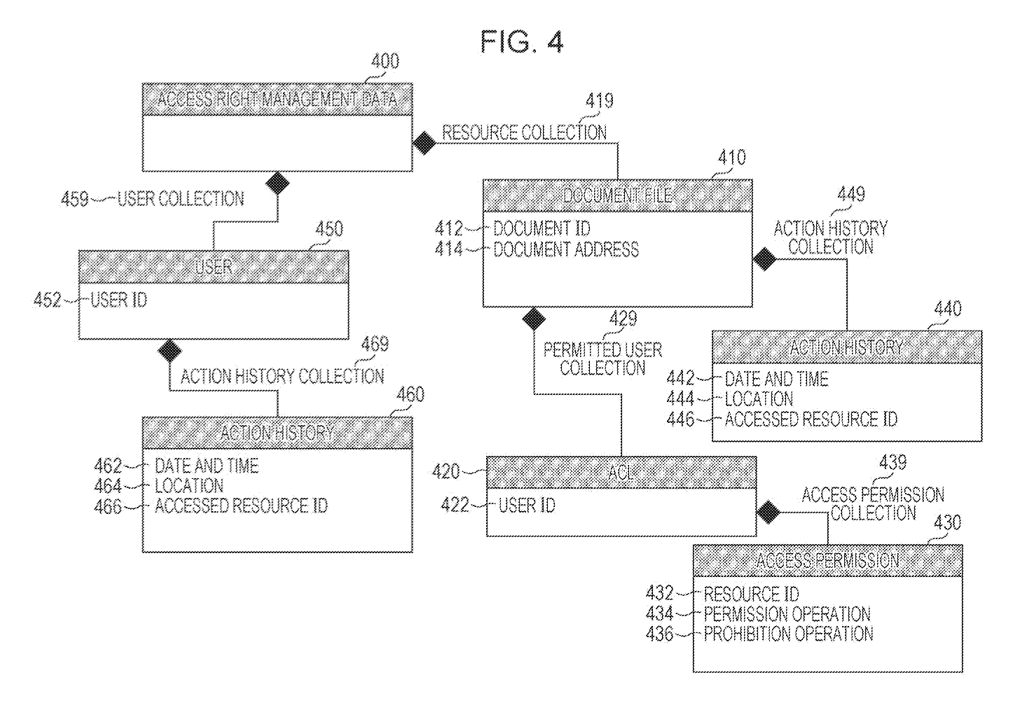

FIG. 4 illustrates an exemplary data structure of targets in the present exemplary embodiment.

Referring to FIG. 4, access right management data 400 includes a resource collection 419 and a user collection 459. The resource collection 419 is a collection of a document file 410. The collection includes a null set. The document file 410 includes a document ID 412, a document address 414, a permitted user collection 429, and an action history collection 449. The permitted user collection 429 is a collection of an ACL 420. The ACL 420 includes a user ID 422 and an access permission collection 439. The access permission collection 439 is a collection of access permission 430. The access permission 430 includes a resource ID 432, a permission operation 434, and a prohibition operation 436. The action history collection 449 is a collection of an action history 440. The action history 440 includes a date and time 442, a location 444, and an accessed resource ID 446. The user collection 459 is a collection of a user 450. The user 450 includes a user ID 452 and an action history collection 469. The action history collection 469 is a collection of an action history 460. The action history 460 includes a date and time 462, a location 464, and an accessed resource ID 466.

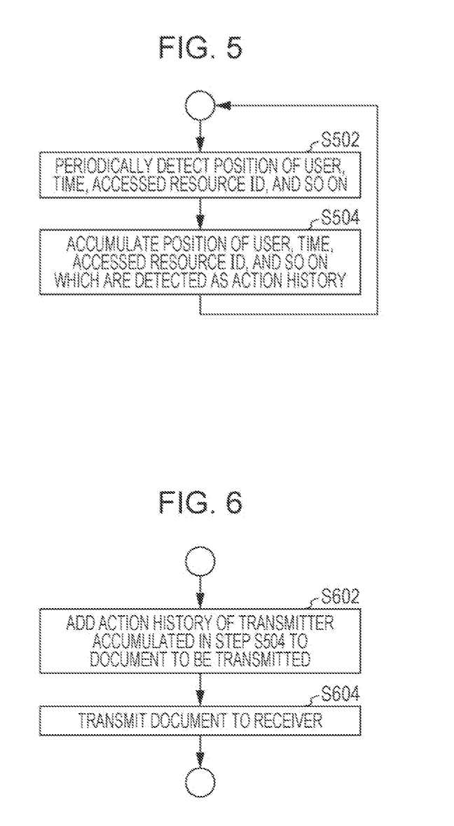

FIG. 5 is a flowchart illustrating an exemplary process (an exemplary process of collecting the action history of the user, performed by the user context detecting module 110) according to the exemplary embodiment.

Referring to FIG. 5, in Step S502, the user context detecting module 110 periodically detects the position of the user, the time, the accessed resource ID, and so on. The resource is, for example, the multi-function peripheral or the PC, described above.

In Step S504, the user context detecting module 110 accumulates the position of the user, the time, the accessed resource ID, and so on, detected in Step S502, as the action history.

FIG. 6 is a flowchart illustrating an exemplary process (an exemplary process of adding the context to transmit the document, performed by the context addition and transmission module 130) according to the exemplary embodiment.

Referring to FIG. 6, in Step S602, the context addition and transmission module 130 adds the action history of the transmitter accumulated in the flowchart illustrated in FIG. 5 to the document to be transmitted.

In Step S604, the context addition and transmission module 130 transmits the document to the receiver.

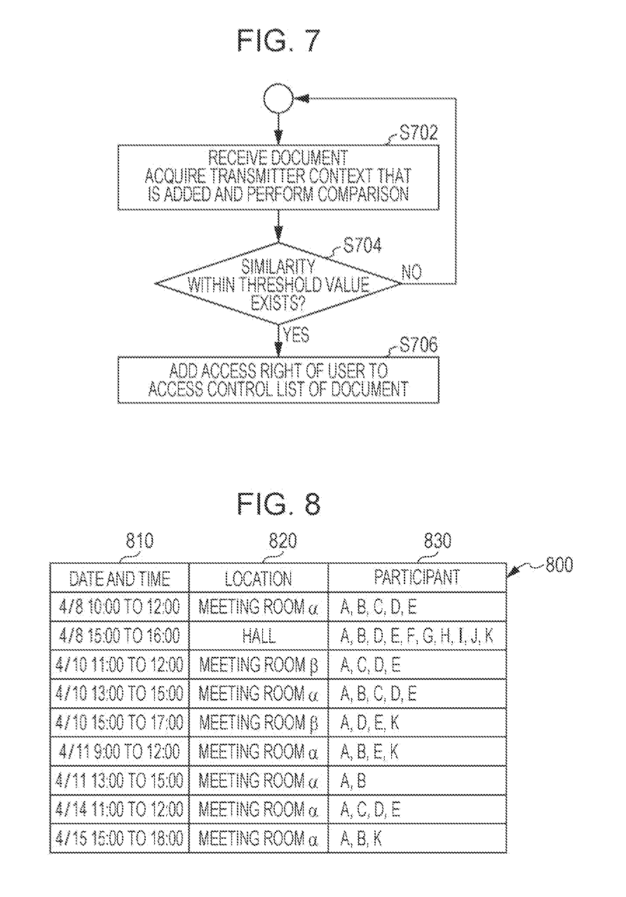

FIG. 7 is a flowchart illustrating an exemplary process (an exemplary process of activating the authority in accordance with the similarity of the action histories, performed by the access right setting module 150) according to the exemplary embodiment.

Referring to FIG. 7, in Step S702, the access right setting module 150 receives the document. The access right setting module 150 acquires the context of the transmitter, which is added to the document, and compares the context of the transmitter with the context of the receiver.

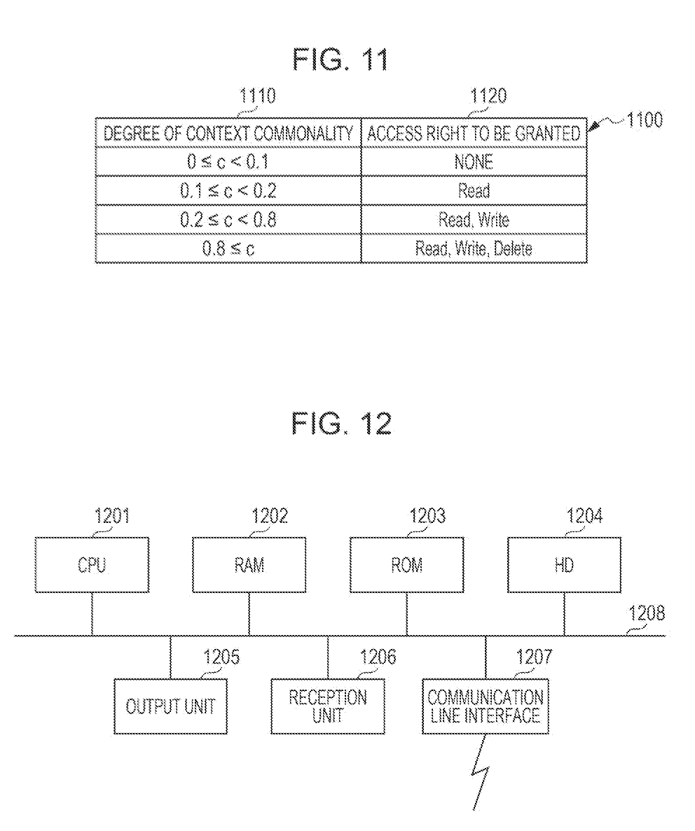

In Step S704, the access right setting module 150 determines whether the similarity is within threshold values. If the access right setting module 150 determines that the similarity is within the threshold values (YES in Step S704), the process goes to Step S706. The process otherwise (NO in Step S704) goes back to Step S702. The determination step is described below with reference to an example in FIG. 11.

In Step S706, the access right setting module 150 adds the access right of the user to the access control list of the document.

A description will be given with reference to FIG. 8 to FIG. 11.

### (Storage of Context)

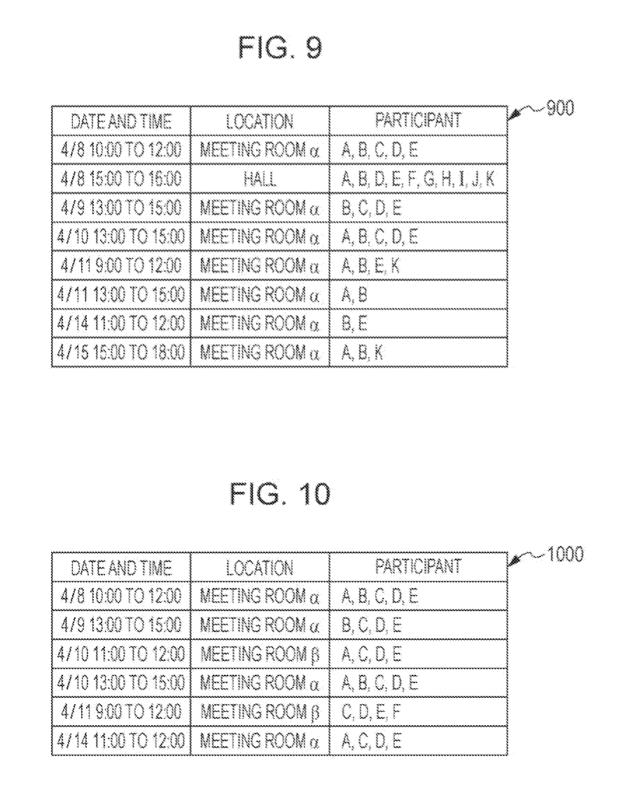

The user A: 232A, the user B: 232B, and the user C: 232C each register the schedule of a collaborative work, such as a meeting, in the schedule management system 220. For example, the user A: 232A registers the schedule of the collaborative work in user A schedule data 800. FIG. 8 illustrates an exemplary data structure of the user A schedule data 800. The user A schedule data 800 includes a date and time field 810, a location field 820, and a participant field 830. The date and time field 810 stores the date and time of the collaborative work as a schedule. The location field 820 stores the location where the collaborative work is performed. The participant field 830 stores the participants in the collaborative work. The user B: 232B registers the schedule of the collaborative work in user B schedule data 900. FIG. 9 illustrates an exemplary data structure of the user B schedule data 900. The user C: 232C registers the schedule of the collaborative work in user C schedule data 1000. FIG. 10 illustrates an exemplary data structure of the user C schedule data 1000. The data structures of the user B schedule data 900 and the user C schedule data 1000 are equivalent to the data structure of the user A schedule data 800.

### (Registration of Document and Notification of Storage Destination)

The user A: 232A creates the document α 320 and stores the created document α 320 in the document sharing server 210. In the document sharing server 210, the ID of the creator is stored as the attribute information about the document.

The user A: 232A notifies the user B: 232B and the user C: 232C of the storage destination of the document α 320, which is registered, using the electronic mail or the like.

### (Access to Document by Others and Grant of Access Right)

The user B: 232B and the user C: 232C each access the storage destination of the document α 320 notified from the user A: 232A using the electronic mail. The document sharing server 210 detects that no entry of the access rights of the user B: 232B and the user C: 232C exists in the access control list of the document α 320 and requests the access right grant service apparatus 200 to determine the access right and grant the access right.

Upon reception of the above request, the access right grant service apparatus 200 acquires the context histories (corresponding to past one week) of the user A: 232A (determined from the creator ID), who is the creator, the user B: 232B, and the user C: 232C, which are set as the attributes of the document α 320, from the schedule management system 220. The “past one week” corresponds to April 9 to April 15. The access right grant service apparatus 200 extracts the schedule information on April 9 to April 15 from the user A schedule data 800, the user B schedule data 900, and the user C schedule data 1000 illustrated in FIG. 8 to FIG. 10, respectively.

The access right grant service apparatus 200 calculates the degree of context commonality between the user A: 232A and the user B: 232B and the degree of context commonality between the user A: 232A and the user C: 232C from the acquired context histories.

The degree of context commonality (user A, user B)=10 h/(8 h×5 days)=0.25

The degree of context commonality (user A, user C)=4 h/(8 h×5 days)=0.1

In the above equations, “five days” correspond to working days in the past one week and “eight hours” correspond to working hours in one day. In the user A schedule data 800 and the user B schedule data 900, the total time spent on the meeting in which both, the user A: 232A and the user B: 232B participate is 10 hours during a period from April 9 to April 15. In the user A schedule data 800 and the user C schedule data 1000, the total time spent on the meeting in which both the user A: 232A and the user C: 232C participate is four hours during the period from April 9 to April 15.

An access right grant rule, such as a degree of commonality and access right correspondence table 1100, is set in the access right grant service apparatus 200. FIG. 11 illustrates an exemplary data structure of the degree of commonality and access right correspondence table 1100. The degree of commonality and access right correspondence table 1100 includes a degree of context commonality field 1110 and an access right to be granted field 1120. The degree of context commonality field 1110 stores the degree of context commonality. The access right to be granted field 1120 stores the access right to be granted in accordance with the degree of context commonality. The access rights of the user B: 232B and the user C: 232C are added to the access control list of the document α 320 stored in the document sharing server 210 on the basis of the access right grant rule. Specifically, the “Read right” and the “Write right” are granted to the user B: 232B because the degree of context commonality of the user B: 232B with the user A: 232A is 0.25. The “Read right” is granted to the user C: 232C because the degree of context commonality of the user C: 232C with the user A: 232A is 0.1.

A computer in which the programs according to the exemplary embodiment are executed has the hardware configuration of a general computer, as illustrated in FIG. 12. Specifically, the computer is, for example, a personal computer or a server. More specifically, the computer uses a CPU 1201 as a processor (an arithmetic unit) and uses a RAM 1202, a read only memory (ROM) 1203, and a hard disk (HD) 1204 as memories. The computer includes the CPU 1201 that executes the programs of, for example, the user context detecting module 110, the user context history holding module 120, the context addition and transmission module 130, the access right managing module 140, and the access right setting module 150; the RAM 1202 that stores the programs and data; the ROM 1203 that stores a program to hoot the computer and so on; the HD 1204 that serves as an auxiliary memory (may be a flash memory); an output unit 1205, such as a cathode ray tube (CRT) or a liquid crystal display; a reception unit 1206 that receives data on the basis of an operation by the user with, for example, a keyboard, a mouse, or a touch panel; a communication line interface 1207 to connect to a communication network, such as a network interface card; and a bus 1208 via which the above components are connected to each other to exchange data. Multiple such computers may be connected to each other via a network.

In the exemplary embodiment embodied by the computer program, among the above exemplary embodiments, the system having the above hardware configuration reads the computer program, which is software, to realize the exemplary embodiment through cooperation of the software and the hardware resources.

The hardware configuration illustrated in FIG. 12 is only an example and the present exemplary embodiment is not limited to the configuration illustrated in FIG. 12 as long as the modules described in the above exemplary embodiments are capable of being executed. For example, part of the modules may be configured by dedicated hardware (for example, an application specific integrated circuit (ASIC)), part of the modules may exist in an external system and the external modules may be connected to the system via the communication line, or multiple systems illustrated in FIG. 12 may be connected to each other via the communication line for collaboration. The system illustrated in FIG. 12 may be incorporated in a home information appliance, a copier, a facsimile, a scanner, a printer, or a multi-function peripheral, instead of the personal computer.

The programs described above may be stored in a recording medium for provision or the programs may be provided using a communication unit. In this case, the programs described above may be understood as an exemplary embodiment of a “computer-readable recording medium on which the programs are recorded.”

The “computer-readable recording medium on which the programs are recorded” means a computer-readable recording medium on which the programs are recorded and which is used for installation, execution, and distribution of the programs.

The recording medium may be a digital versatile disk (DVD), such as a DVD-R, a DVD-RW, or a DVD-RAM conforming to a standard developed in a DVD forum or a DVD+R or a DVD+RW conforming to a standard developed with DVD+RW; a compact disc (CD), such as a CD-ROM, a CD-recordable (CD-R), or a CD-rewritable (CD-RW); a Blue-ray disc (registered trademark); a magneto-optical (MO) disk; a flexible disk (FD); a magnetic tape; a hard disk; a ROM; an electrically erasable and programmable read only memory (EEPROM (registered trademark)); a flash memory; a RAM; or a secure digital (SD) memory card.

The programs described above or part of the programs may be recorded on the recording medium for storage or distribution. Alternatively, the programs described above or part of the programs may be transmitted through communication, for example, using a transmission medium composed of a wired network used for a local area network (LAN), a metropolitan area network (MAN), a wide area network (WAN), the Internet, an intranet, or an extranet; a wireless communication network; or a combination of them. The programs described above or part of the programs may be carried on carrier waves.

Each program described above may be part of another program or may be recorded on the recording medium along with another program. The program described above may be divided to be recorded on multiple recording media. The program described above may be recorded in any recoverable mode, such as in a compressed mode or an encoded mode.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document management apparatus comprising:
a receiving unit that receives a document to which a first user has an access right and an action history of the first user; and
a granting unit that, if a similarity between the action history of the first user and an action history of a second user is higher than or equal to a threshold value, grants the access right to the document to the second user.

2. The document management apparatus according to claim 1,
wherein the granting unit calculates the similarity between the action history of the first user and the action history of the second user in a process of creating the document.

3. The document management apparatus according to claim 1,
wherein the granting unit calculates the similarity between the action history of the first user and the action history of the second user during a predetermined period.

4. The document management apparatus according to claim 2,
wherein the granting unit calculates the similarity between the action history of the first user and the action history of the second user during a predetermined period.

5. The document management apparatus according to claim 1,
wherein a plurality of threshold values are set, and
wherein the granting unit grants plural kinds of access right to the document to the second user based on the plurality of threshold values.

6. The document management apparatus according to claim 1,
wherein the granting unit performs the granting when the document is passed from the first user to the second user, and
wherein the granting unit deletes the access right to the document, which is granted to the second user, if the similarity between the action history of the first user and the action history of the second user is lower than or equal to the threshold value for every predetermined period after the access right, is granted by the granting unit or the granting unit grants the access right after an expiry date of the access right.

7. The document management apparatus according to claim 1,
wherein the granting unit performs the granting when the document is passed from the first user to the second user, and
wherein the granting unit again grants the access right after an expiry date of the access right.

8. A non-transitory computer readable medium storing a program causing a computer to execute a process comprising:
receiving a document to which a first user has an access right and an action history of the first user; and
granting, if a similarity between the action history of the first user and an action history of a second user is higher than or equal to a threshold value, the access right to the document to the second user.

9. A document-management method comprising:
receiving a document to which a first user has an access right end an action history of the first user; and
granting, if a similarity between the action history of the first user and an action history of a second user is higher than or equal to a threshold value, the access right to the document to the second user.
